(19) United States
(12) Patent Application Publication
(10) Pub. No.: US 2026/0046894 A1
(43) Pub. Date: Feb. 12, 2026

(54) METHODS, DEVICES AND COMPUTER STORAGE MEDIA OF COMMUNICATION

(71) Applicant: NEC Corporation, Tokyo (JP)

(72) Inventors: Peng GUAN, Beijing (CN); Gang WANG, Beijing (CN)

(73) Assignee: NEC Corporation, Tokyo (JP)

(21) Appl. No.: 19/102,563

(22) PCT Filed: Aug. 11, 2022
(86) PCT No.: PCT/CN2022/111928

§ 371 Date: Feb. 10, 2025

(51) Int. Cl. H04W 72/232; H04B 7/06

(52) U.S. Cl. CPC H04W 72/232; H04B 7/06952

(57) ABSTRACT

Embodiments of the present disclosure relate to methods, devices, and computer storage media for communication. From a repeating device, a network device receives an indication of correlation of a backhaul beam and a control beam of the repeating device. The backhaul beam is used for a backhaul link between the network device and the repeating device, and the control beam is used for a control link between the network device and the repeating device. The network device indicates at least one of the backhaul or access beam to the repeating device.

### TECHNICAL FIELD

Embodiments of the present disclosure generally relate to the field of telecommunication, and specifically relate to methods, devices, and computer storage media of communication.

### BACKGROUND

Coverage is a fundamental aspect of cellular network deployments. Mobile operators rely on different types of network nodes (or network devices) to offer blanket coverage in their deployments. Deployment of regular full-stack cells is one option, but it may not be always possible (for example, due to no availability of backhaul) or economically viable. Radio Frequency (RF) repeaters as a new type of network nodes have been widely deployed to supplement the coverage provided by regular full-stack cells.

An RF repeater generally performs amplify-and-forward operations without considering various factors that could improve performance. A network-controlled repeater (NCR) is an enhancement over RF repeaters. The NCR has the capability to receive and process side control information from a network to improve the amplify-and-forward operations. The side control information may comprise beamforming information for Beam management (BM) of the NCR. There is a need to design BM operations for an NCR to extend network coverage in a higher efficient way.

### SUMMARY

In general, embodiments of the present disclosure provide methods, devices, and computer storage media of communication.

In a first aspect, there is provided a method performed by a network device. The method comprises receiving, from a repeating device, an indication of correlation of a backhaul beam and a control beam of the repeating device, the backhaul beam used for a backhaul link between the network device and the repeating device, and the control beam used for a control link between the network device and the repeating device; and indicating, to the repeating device, at least one of the backhaul or access beam.

In a second aspect, there is provided a method performed by a network device. The method comprises determining that at least one of a beam of the network device or a backhaul beam of a repeating device is changed during a first channel measurement of a terminal device via beam sweeping, the backhaul beam used for a backhaul link between the network device and the repeating device; and in accordance with a determination that the at least one of the beam of the network device or the backhaul beam of the repeating device is changed, transmitting, to the terminal device, a deactivation indication of a channel state information report of the terminal device.

In a third aspect, there is provided a method performed by a network device. The method comprises determining whether second channel measurement of a repeater device is completed in a link between the network device and the repeating device; and in accordance with a determination that the second channel measurement is completed, transmitting, to the repeating device, an indication of enabling a forwarding module of the repeating device for forwarding to a terminal device.

In a fourth aspect, there is provided a method performed by a repeating device. The method comprises transmitting, to a network device, an indication of correlation of a backhaul beam and a control beam of the repeating device, the backhaul beam used for a backhaul link between the network device and the repeating device, and the control beam used for a control link between the network device and the repeating device; and receiving, from the network device, at least one indication associated with at least one of the backhaul or access beam.

In a fifth aspect, there is provided a method performed by a repeating device. The method comprises determining that at least one condition is met, the at least one condition comprising at least one of: a condition that a second channel measurement of the repeater device is completed in a link between the repeater device and a network device, or a condition that an indication of enabling a forwarding module of the repeating device is received from the network device; and in accordance with a determination that the at least one condition is met, enabling the forwarding module of the repeating device for forwarding to a terminal device.

In a sixth aspect, there is provided a method performed by a terminal device. The method comprises receiving, from a network device, a deactivation indication of a channel state information report during channel measurement of a terminal device via beam sweeping; and ceasing the channel state information report.

In a seventh aspect, there is provided a network device. The network device comprises a processor and a memory. The memory is coupled to the processor and stores instructions thereon. The instructions, when executed by the processor, cause the network device to perform the method according to the first, second or third aspect of the present disclosure.

In an eighth aspect, there is provided a repeating device. The repeating device comprises a processor and a memory. The memory is coupled to the processor and stores instructions thereon. The instructions, when executed by the processor, cause the repeating device to perform the method according to the fourth or fifth aspect of the present disclosure.

In a ninth aspect, there is provided a terminal device. The repeating device comprises a processor and a memory. The memory is coupled to the processor and stores instructions thereon. The instructions, when executed by the processor, cause the terminal device to perform the method according to the sixth aspect of the present disclosure.

In a tenth aspect, there is provided a computer readable medium having instructions stored thereon. The instructions, when executed on at least one processor, cause the at least one processor to perform the method according to one of the above aspects of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features, and advantages of the present disclosure will become more apparent, wherein:

FIG. 1 illustrates a schematic diagram of an example communication network in which some embodiments of the present disclosure can be implemented;

FIG. 2 illustrates a high-level signaling diagram of an example beam indication process according to some embodiments of the present disclosure;

FIG. 3 illustrates a diagram of an example beam indication method according to some embodiments of the present disclosure;

FIG. 4 illustrates a diagram of an example implementation of the beam index of the access beam according to some embodiments of the present disclosure;

FIGS. 5A to 5E illustrates diagrams of example mapping of the backhaul and control beams according to some embodiments of the present disclosure;

FIG. 6 illustrates a diagram of an example process of determining the effective time of the indicated beam according to some embodiments of the present disclosure

FIG. 7 illustrates a diagram of an example beam indication method according to some embodiments of the present disclosure;

FIG. 8 illustrates a diagram of an example process of finer beam training according to some embodiments of the present disclosure;

FIG. 9 illustrates a diagram of an example method of updating a CSI-RS configuration according to some embodiments of the present disclosure;

FIG. 10 illustrates a diagram of an example process of updating a configuration of a CSI-RS according to some embodiments of the present disclosure;

FIG. 11 illustrates a diagram of an example method of updating a CSI-RS configuration according to some embodiments of the present disclosure;

FIG. 12 illustrates a diagram of an example method of enabling forwarding operations of the repeating device according to some embodiments of the present disclosure;

FIG. 13 illustrates a diagram of an example process of enabling the forwarding operations according to some embodiments of the present disclosure;

FIG. 14 illustrates a diagram of an example method of enabling the forwarding operations of the repeating device according to some embodiments of the present disclosure;

FIG. 15 illustrates a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purposes of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Small Data Transmission (SDT), mobility, Multicast and Broadcast Services (MBS), positioning, dynamic/flexible duplex in commercial networks, reduced capability (RedCap), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The “terminal device” can further have ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal, or a wireless device.

The term “network device” refers to a device which is capable of providing or hosting a cell or coverage where terminal devices can communicate. Examples of a network in device include, but not limited to, a Node B (NodeB or NB), an evolved NodeB (cNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like. In some embodiments, the network device may be also referred to a network node.

The terminal device or the network device may have Artificial intelligence (AI) or Machine learning capability. It generally includes a model which has been trained from numerous collected data for a specific function and can be used to predict some information.

The terminal or the network device may work on several frequency ranges, e.g., FR1 (410 MHz to 7125 MHZ), FR2 (24.25 GHz to 71 GHz), frequency band larger than 100 GHz as well as Tera Hertz (TH). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex, and cross division duplex modes.

The embodiments of the present disclosure may be performed in test equipment, e.g., signal generator, signal analyzer, spectrum analyzer, network analyzer, test terminal device, test network device, channel emulator.

In some embodiments, the terminal device may be connected to a first network device and a second network device. One of the first network device and the second network device may be a master node and the other one may be a secondary node. The first network device and the second network device may use different radio access technologies (RATs). In some embodiments, the first network device may be a first RAT device and the second network device may be a second RAT device. In some embodiments, the first RAT device is eNB and the second RAT device is gNB. Information related with different RATs may be transmitted to the terminal device from at least one of the first network device or the second network device. In some embodiments, first information may be transmitted to the terminal device from the first network device and second information may be transmitted to the terminal device from the second network device directly or via the first network device. In some embodiments, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms “a,” “an” and “the” are intended to include the plural forms as well, unless the context clearly indicates otherwise. The term “includes” and its variants are to be read as open terms that mean “includes, but is not limited to.” The term ‘based on’ is to be read as “at least in part based on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As used herein, the term “repeating device” refers to a device which can provide an amplify-and-forward function between a terminal device and a network device, especially, the terminal device is out of coverage of the network device. In some embodiments, the repeating device may receive control information from the network device to enhance the amply-and-forward function. Examples of the repeating device may include, but not be limited to, Network-controlled Repeaters (NCRs), Reconfigurable Intelligent Surface (RIS), and/or the like. For the purposes of discussion, some embodiments of the present disclosure will be discussed by taking an NCR as an example of the repeating device.

In some embodiments, the repeating device may comprise a control module and a forwarding module. The control module communicates with a network device via a control link, for example, to receive the control information. The forwarding module performs amplify-and-forwarding of UL/DL RF signals between a network device and a terminal device via a backhaul link and an access link. The control and forwarding modules may be implemented as hardware, firmware, and/or algorithm-based software components of the repeating device and may be collocated or apart from each other. Examples of the control and forwarding modules may include, but not be limited to, an NCR mobile terminal (MCR-MT) and an NCR forwarding (NCR-Fwd). For the purposes of discussion, some embodiments of the present disclosure will be discussed by taking the MCR-MT and NCR-Fwd as examples of the control and forwarding modules of the repeating device.

As discussed above, coverage is a fundamental aspect of cellular network deployments. However, deployment of regular full-stack cells may not be always possible or economically viable. New types of nodes have been considered to increase flexibility of mobile operators for network deployments. For example, Integrated Access and Backhaul (IAB) may be used as a new type of nodes not requiring a wired backhaul to provide coverage enhancement.

Another type of nodes is a Radio Frequency (RF) repeater which may amplify-and-forward any received signal. There may have been a wide range of deployments of RF repeaters in the second generation (2G), the third generation (3G) and the fourth generation to supplement the coverage provided by regular full-stack cells. RF and Electro Magnetic Compatibility (EMC) requirements may be designed for the RF repeaters in New Radio (NR) targeting both FR1 and FR2.

An RF repeater presents cost effective means of extending the network coverage. However, generally, an RF repeater may simply perform amplify-and-forward operations without being able to consider various factors that could improve performance. Such factors may include information on semi-static and/or dynamic downlink (DL)/uplink (UL) configurations, adaptive transmitter/receiver spatial beamforming, ON-OFF status, and/or the like.

A network-controlled repeater (NCR) is an enhancement over RF repeaters with simple amplify-and-forward functions. The NCR has the capability to receive and process the side control information from a network. The side control information may allow an NCR to perform the amplify-and-forward operations in a more efficient manner. Potential benefits may include mitigation of unnecessary noise amplification, transmissions and receptions with better spatial directivity, and simplified network integration, and/or the like.

An NCR may include an NCR mobile terminal (NCR-MT) and an NCR forwarding (NCR-Fwd). The NCR-MT may function as an entity or module to communicate with a network device (such as a gNB) via a Control link (C-link) to enable exchanges of information (such as the side control information) between the network device and the NCR. The C-link may be based on a New Radio (NR) Uu interface. The NCR-Fwd may function as an entity or module to perform amplify-and-forwarding of UL/DL RF signals between the network device and a terminal device (such as a UE) via a backhaul link and an access link. Behaviors of the NCR-Fwd may be controlled according to the side control information received by the MCR-MT from the network device.

The side control information may comprise the following information for an NCR: beamforming information, timing information to align transmission/reception boundaries of an NCR, information on UL-DL TDD configuration, ON-OFF information for efficient interference management and improved energy efficiency, power control information for efficient interference management, and/or the like. With beamforming information for beam management (BM) based on the NCR, the network coverage may be enhanced, particularly, in high frequency (HF). However, there is no effective and efficient approach to indicate the beamforming information from the network to the NCR.

Some embodiments of the present disclosure provide a beam indication scheme for a repeating device (such as an NCR). With the scheme, a repeating device reports correlation of a backhaul beam and a control beam of the repeating device to a network device (such as a gNB). The backhaul and control beams are used for backhaul and control links between the network device and the repeating device, respectively. The correlation of the backhaul and control beams may reply on a network plan and/or hardware information or settings of the repeating device, for example, depending on relative positions of a control module (for example, an NCR-MR) and a forwarding module (for example, an NCR-Fwd) of the repeating device, or the numbers or arrangements of antennas of the two modules.

With consideration of the correlation of the backhaul and control beams, the network device indicates at least one of a backhaul beam or an access beam to the repeating device depending on or independent of the correlation of the backhaul and control beams. For example, if the correlation of the backhaul and control beams is relatively high, the network device may use an indication of the control beam to implicit indicate the backhaul beam. The network device may also transmit to the repeating device indications dedicated to the backhaul and access beams or a joint indication of both the backhaul and access beams independent of the correlation of the backhaul and control beams.

In this way, a backhaul beam and/or an access beam may be effectively and efficiently indicated by the network device to the repeating device. Based on such indications, the beams for the repeating device may be determined uniquely, thereby mitigating misalignment. Furthermore, transmitter/receiver spatial beamforming may be facilitated, and better spatial directivity may be achieved.

Principles and implementations of the present disclosure will be described in detail below with reference to the figures.

### Example of Communication Network

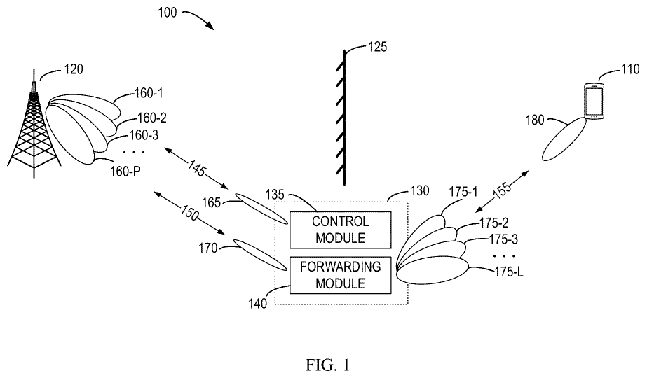

FIG. 1 illustrates a schematic diagram of an example communication network 100 in which some embodiments of the present disclosure can be implemented.

As shown in FIG. 1, the communication network 100 may include a terminal device 110 and a network device 120 that may serve the terminal device 110. Between the terminal device 110 and the network device 120, a block 125 may block out communications between the two devices 110 and 120 and thus cause a blocked or blind area out of coverage of the network device 120. The communication network 100 may further include a repeating device 130 to forward the communications between the two devices 110 and 120 in a blocked or blind area.

It is to be understood that the number of devices in FIG. 1 is given for the purposes of illustration without suggesting any limitations to the present disclosure. The communication network 100 may include any suitable number of terminal devices, network devices, and/or repeating devices adapted for implementations of the present disclosure.

In some embodiments, the terminal device 110 and the network device 120 may communicate via the repeating device 130 with each other via a channel such as a wireless communication channel on an air interface (e.g., Uu interface). The wireless communication channel may comprise a physical uplink control channel (PUCCH), a physical uplink shared channel (PUSCH), a physical random-access channel (PRACH), a physical downlink control channel (PDCCH), a physical downlink shared channel (PDSCH) and a physical broadcast channel (PBCH). Of course, any other suitable channels are also feasible.

The communications in the communication network 100 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

As shown in FIG. 1, the repeating device 130 may include a control module 135 and a forwarding module 140. The control module 135 may communicate with the network device 120 via a control link 145. The forwarding module 140 may perform amplify-and-forwarding of UL/DL RF signals between the network device 120 and the terminal device 110 via a backhaul link 150 and an access link 155.

The control module 135 and the forwarding module 140 may have any suitable relative positions which may depend on network deployment or plan and/or hardware settings of the two modules 135 and 140 such as the number of antenna panels and/or the number of antennas. The control module 135 is shown to be collocated with or very close to the forwarding module 140 in FIG. 1 only for the purposes of illustration without suggesting any limitation. In some embodiments, the control module 135 may be separate from or even far way from the forwarding module 140 and cooperate with a plurality of forwarding modules if a plurality of blocks is present and interrupt transmission of RF signals between the network device 120 and the terminal device 110 in the communication network 100.

Beamforming may be used for communications in the communication network 100 to achieve better spatial directivity. As shown in FIG. 1, the network device 120 may use beams 160-1, 160-2, 160-3 . . . 160-P (individually or collectively referred to as a beam 160) to communicate with the repeating device 130. The repeating device 130 may use a control beam 165 to communicate with the network device 120 via the control link 145 and use a backhaul beam 170 to communicate with the network device 120 via the backhaul link 150. The repeating device 130 may further use access beams 175-1, 175-2, 175-3 . . . 175-L (individually or collectively referred to as an access beam 175) to communicate via the access link 155 with the terminal device 110 that may use a beam 180. P and L may represent any suitable integers.

It is to be understood that the numbers of beams configured for the terminal device 110, the network device 120 and the repeating device 130 are shown in FIG. 1 only for the purposes of illustration without suggesting any limitation. Depending on the network plan and the capabilities of the devices 110, 120 and 130 in the communication network 100, the device 110, 120 or 130 may be provided with any suitable number of beams.

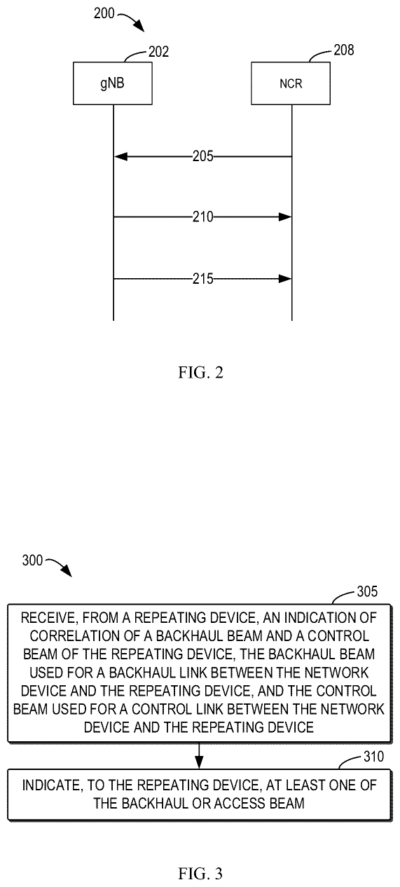

In some embodiments of the present disclosure, the backhaul beam 170 and/or the access beam 180 of the repeating device 130 may be configured by the network device 120 via the control link 145. The backhaul beam 170 and/or the access beam 175 may be indicated by the network device 120 with the consideration of correlation of the control beam 165 and the backhaul beam 170. The correlation may be indicated by the repeating device 130 to the network device 120. An example beam indication process will be discussed below with reference to FIG. 2 by taking a gNB as an example of the network device 120, an NCR as an example of the repeating device 130, and an NCR-MT and an NCR-Fwd as examples of the control and forwarding modules 135 and 140.

FIG. 2 shows a high-level signaling diagram of a beam indication process 200 according to some embodiments of the present disclosure. For the purposes of discussion, the diagram 200 will be discussed with reference to FIG. 1.

As shown in FIG. 2, a gNB 202 may receive (205) capability related to beam correlation between an NCR-MT and an NCR-Fwd of an NCR 208. The gNB 202 may indicate (210) a backhaul (BH) beam and an access (AC) beam of the NCR 208 based on the reported capability. Then, the gNB 202 may transmit (215) signals via beams corresponding to the indicated beams.

The capability of correlation may include a correlation value range from 0 to 1, where “0” means no correlation and “1” means completely correlation, or a correlation type such as high correlation, middle correlation, and low correlation, and/or the like. In the case that the correlation value is larger than a first threshold or the correlation type is the high correlation, a beam index associated with a beam width for the access beam may be indicated separately or independently, while a beam index of the BH beam may be associated with the beam of the NCR-MT. In the case that the correlation value is smaller than a second threshold or the correlation type is the low correlation, a joint beam index associated with beam widths of both the access beam and the backhaul beam may be indicated. The bit length of the beam index may be decided by the beam width.

In some embodiments, an indication of a beam (also called a beam indication) for the NCR-MT may reuse the legacy procedure and signaling, including Transmission configuration indicator (TCI) state configurations in Radio Resource Control (RRC), Media Access Control-Control Element (MAC-CE) and Downlink Control Information (DCI). In some embodiments, a beam indication for a backhaul link of the NCR-Fwd may be the same as that of the NCR-MT. The backhaul beam may be derived according to that of the NCR-MT. Alternatively, or in addition, the beam indication for the backhaul link may be independent from that of the NCR-MT. An explicitly indication may be used irrespective what beam is used for the NCR-MT.

In some embodiments, a beam indication for an access link of the NCR-Fwd may be a combined indication with that for the backhaul link of the NCR-Fwd, or an independent indication with that for the backhaul link of the NCR-Fwd.

FIG. 3 shows an example beam indication method 300 according to some embodiments of the present disclosure. The method 300 can be implemented by the network device 120. For the purposes of discussion, the method 300 will be discussed from the perspective of the network device 120 with reference to FIG. 1.

As shown in FIG. 3, at block 305, the network device 120 receives from the repeating device 130 an indication of correlation of the backhaul beam 170 and the control beam 165 of the repeating device 130. The correlation of the two beams 165 and 170 may be associated with the relative locations of the control module 135 and the forwarding module 140. For example, if the two modules 135 and 140 are arranged to be near to each other, the correlation between the backhaul beam 170 and the control beam 165 may be relatively higher or larger than a first threshold. In some embodiments, the indication of the correlation may indicate a correlation value range from 0 to 1, or a level of correlation (or a correlation type) such as a high level (or high correlation), a middle level (middle correlation) and a low level (low correlation).

At block 310, the network device 120 indicates at least one of the backhaul beam 170 or the access beam 175. In some embodiments, the backhaul and access beams 170 and 175 may be indicated depending on the correlation of the backhaul beam 170 and the control beam 165. For example, if a level of the correlation is equal to or higher than a threshold level, an indication of the control beam 165 may be reused to indicate at least partially the backhaul beam 170.

In some embodiments, the indication of the control beam 165 may reuse the legacy procedure and signaling, including TCI state configurations in RRC, MAC-CE and DCI.

For example, a UE (as an example of the terminal device 110) or the NCR-MT may be configured with a list of up to M TCI-State configurations within the higher layer parameter PDSCHConfig (where M depends on the UE capability maxNumberConfiguredTCIstatesPerCC) to decode a PDSCH according to a detected PDCCH with DCI intended for the UE and the given serving cell. Each TCI-State may contain parameters for configuring a quasi co-location relationship between one or two downlink reference signals and the demodulation reference signal (DM-RS) ports of the PDSCH, the DM-RS port of PDCCH or the Channel State Information Reference Signal (CSI-RS) port(s) of a CSI-RS resource.

The quasi co-location relationship may be configured by the higher layer parameter qcl-Type1 for the first DL RS, and qcl-Type2 for the second DL RS (if configured). For the case of two DL RSs, Quasi-co-located (QCL) types may not be the same, regardless of whether the references are to the same DL RS or different DL RSs. The quasi co-location types corresponding to each DL RS may be given by the higher layer parameter qcl-Type in QCL-Info and may take one of the following values:
‘typeA’: {Doppler shift, Doppler spread, average delay, delay spread}
‘typeB’: {Doppler shift, Doppler spread}
‘typeC’: {Doppler shift, average delay}
‘typeD’: {Spatial Rx parameter}

The UE may receive an activation command, used to map up to 8 TCI states to the codepoints of the DCI field ‘Transmission Configuration Indication’ in one Component Carrier (CC)/DL Bandwidth Part (BWP) or in a set of CCs/DL BWPs, respectively. When a set of TCI state IDs are activated for a set of CCs/DL BWPs, where the applicable list of CCs is determined by indicated CC in the activation command, the same set of TCI state IDs may be applied for all DL BWPs in the indicated CCs.

TCI may be configured via DCI. For example, for DCI format 1-1, Transmission configuration indication-0 bit if higher layer parameter tci-PresentInDCI is not enabled; otherwise 3 bits. For DCI format 1-2, Transmission configuration indication-0 bit if higher layer parameter tci-PresentDCI-1-2 is not configured; otherwise 1 or 2 or 3 bits determined by higher layer parameter tci-PresentDCI-1-2.

The threshold level may be set according to practical needs or a network plan. For example, it may be predefined that if the level of correlation is equal to or higher than a middle level (as an example of the threshold level), the indication of the control beam 165 may be reused for the backhaul beam 170. As another example, the threshold level may be set to be a high level.

In the case that the backhaul beam 170 is implicitly indicated by the indication of the control beam 165, the network device 120 may further transmit an indication dedicated to the access beam 175 to the repeating device 130. This dedicated indication may comprise a beam index (referred to as a first beam index) of the access beam 175. The first beam index may be associated with a beam width (referred to as a first beam width) of the access beam 175 and/or the number of access beams with the same first beam width. For example, if the first beam width of the access beam 175 is broader, the number of access beams with the same first beam width may be smaller. The required bit length of the first beam index of the access beam 175 may be shorter. If the first beam width is narrower, the number of access beams with the same first beam width may be larger. Accordingly, the bit length of the first beam index may be longer.

The first beam width may be informed by the network device 120 to the repeating device 130 in advance. For example, the network device 120 may send to the repeating device 130 an indication of a beam width for an access beam to be used. Based on such an indication, the repeating device 130 may determine a configuration (such as a bit length) of the first beam index of the access beam 175 and further detect or decode the first beam index according to predefined rules.

In some embodiments, the first beam width may be associated with a channel carried in the access link 155. Accordingly, the first beam index may be related to the associated channel. For example, a common channel such as a PBCH (Physical Broadcasting CHannel) may be associated with an omni-directional beam or a middle beam such that the surrounding devices can detect signals on the common channel with a high probability. Less bits may be needed to indicate an omni-directional beam or a middle beam, and thus the first beam index associated with the common channel may have less bits.

In some embodiments, if the access beam 175 is indicated to be an omni-directional beam, the indication dedicated to the access beam 175 may further indicate an on-off state of the access link 170. As such, the signaling overhead may be reduced, the network efficiency may be improved.

A dedicated channel such as PDSCH and PUSCH channels may be associated with a middle beam or a narrow beam such that the information on such a channel may be received by a specific device. Accordingly, the first beam index associated with a dedicated channel may need more bits.

In some embodiments, the first beam index of the access beam 175 may comprise a predetermined number of bits such that the indication of the access beam 175 occupies a fixed payload to further simplify the processing or operations for side control information decoding of the repeating device 130. Valid bits within the predetermined number of bits may be determined based on the first beam width of the access beam 175.

By way of example, in some embodiments, the backhaul beam of the NCR-Fwd (as an example of the forwarding module 140) may be same as that of the NCR-MT (as an example of the control module 135). An implicit indication or an independent indication with the access link of the NCR-Fwd may be used for the backhaul beam. The backhaul beam may be implicitly indicated by the beam indication of the NCR-MT via TCI state configurations (a QCL information indication).

A dedicated beam index may be indicated for the beam of the access link of the NCR-Fwd. The beam index or the payload may be associated with a beam width and/or the number of beams with the same width.

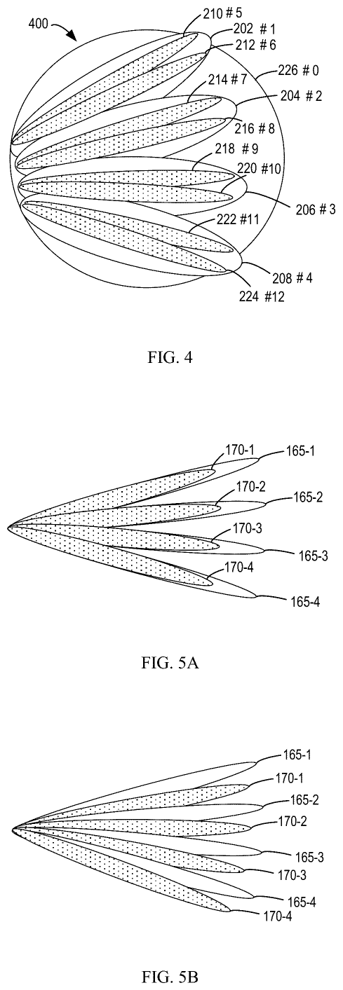

FIG. 4 shows an example implementation 400 of the beam index of the access beam according to some embodiments of the present disclosure.

In the implementation 400, beams 202, 204, 206 and 208 have the same width and may be configured with beam indexes #1, #2, #3 and #4. Beams 210, 212, 214, 216, 218, 220, 222 and 224 have the same width which is narrower than the width of the beams 202, 204, 206 and 208 and may be configured with beam indexes #5, #6, #7, #8, #9, #10, #11 and #12. A beam (the maximum one) 226 is an omni-direction beam with a beam index #0.

It is to be noted that the beam indexes as shown in FIG. 4 are just examples to distinguish the different beams. In some embodiments, the beam indexes of the beams 210 to 224 may be sequentially numbered as #1 to #8 or as #0 to #7. In some embodiments, the beam indexes of the beams 202 to 208 may be sequentially numbered as #0 to #3.

In some embodiments, a beam width may be associated with a channel with a fixed payload of the beam indication. The valid bit(s) within the fixed length indication used to determine the beam may be decided by a beam width applied to a channel. For example, a common channel may be associated with an omni-directional beam (where the first or highest bit may be used and/or valid) or a middle beam (where the first and second beam may be used and/or valid). A PDSCH and/or PUSCH channel may be associated with a middle beam or a narrow beam (where all the bits may be used and/or valid). In some embodiments, an on-off indication of the access link may be joint coded by the omni-directional beam indication.

Just an example, more beam width levels or less beam width levels are not precluded.

Table 1 shows another example implementation of beam indexes.

TABLE 1

| Indicated | | Indicated | | Indicated | |
|---|---|---|---|---|---|
| Beam | Wide beam | Beam | Middle beam | Beam | Narrow beam |
| index | width | index | width | index | width |
| 0 | Off, no beam is | 00 | The 1st | 000 | The 1st narrow |
| | indicated for | | middle width | | beam |
| | access link | | beam | 001 | The 2nd narrow |
| | | | | | beam |
| | | 01 | The 2nd | 010 | The 3rd narrow |
| | | | middle width | | beam |
| | | | beam | 011 | The 4th narrow |
| | | | | | beam |
| 1 | On, Omni- | 10 | The 3rd | 100 | The 5th narrow |
| | directional beam | | middle width | | beam |
| | is used for access | | beam | 101 | The 6th narrow |
| | link | | | | beam |
| | | 11 | The 4th | 110 | The 7th narrow |
| | | | middle width | | beam |
| | | | beam | 111 | The 8th narrow |
| | | | | | beam |

In some embodiments, to reduce complexity for a repeating device to decode the side control information, a fixed scheme or mechanism is used to indicate the at least one of the backhaul beam 170 or the access beam 175 by the network device 120 independent of the correlation of the backhaul beam 170 and the control beam 165. For example, even in the case that the level of the correlation is higher than the threshold level, for example, that the backhaul beam 170 and the control beam 165 are the same due to the colocation of the forwarding module 140 and the control module 135, the network device 120 may transmit a joint indication of the backhaul and access beams 170 and 175 to indicate both the backhaul and access beams 170 and 175.

Similar to the indication for the access beam 175, the joint indication may comprise a beam index (referred to as a second beam index) that may be associated with the first beam width of the access beam 175 and a beam width (referred to as a second beam width) of the backhaul beam 170, the number of access beams with the first beam width and the number of backhaul beams with the second beam width, and/or a channel associated with the backhaul and access beams 170 and 175.

In some embodiments, considering that the locations of the network device 120 and the repeating device 130 may be relatively fixed, but the location of the terminal device 110 may vary over time due to its mobility, a set of bits (referred to as a first set of bits) for the backhaul beam 170 in the second beam index may be prior to a set of bits (referred to as a second set of bits) for the access beam 180. The first and/or second set of bits may include one or more bits or any suitable number of bits. In these embodiments, the backhaul beam 170 may be indicated by the higher bits of the second beam index, and the access beam 180 may be indicated by the lower bits of the second beam index.

Since the locations of the network device 120 and the repeating device 130 may be relatively fixed, a value of the joint indication may vary slower over time. In some embodiments, the network device 120 may indicate a difference between a current value and a previous value of the joint indication to further reduce signaling overhead.

In some embodiments, depending on the relative locations of the network device 120 and the repeating device 130 (for example, the forwarding module 140), the beam 160 of the network device 120 may be pair-bonded with the backhaul beam 170 of the repeating device 130. For example, the network device 120 may determine one or more valid pairs of a backhaul beam 170 of the repeating device 130 and a beam 160 of the network device 120 to exclude some invalid pairs or combinations of the beams 170 and 160. The joint indication of the backhaul and access beams 170 and 175 may be determined by the network device 120 based on the valid pairs of the beams 170 and 160, for example, by excluding a backhaul beam 170 of the invalid pairs of the backhaul beams 170 and the beams 160 of the network device 120. In this way, the second beam index for the joint indication may be determined in an efficient way to further reduce the system overhead and increase the system efficiency.

The valid pair of the beams 170 and 160 may be determined based on information (also called pair information) about a pair of the beams 170 and 160 that may be transmitted by the repeating device 130 to the network device 120. Such pair information may be determined based on measurement on strength of the received signals. The strength of the received signals may be indicated by Reference Signal Receiving Power (RSRP), Received Signal Strength Indicator (RSSI), and/or any other suitable measure based on other suitable criterion.

In some embodiments, the repeating device 120 (such as the control module 135) may measure strength of received signals on a plurality of pairs of the backhaul beams 170 of the repeating device 130 and the beams 160 of the network device 120 and report the results of the measurements to the network device 120. Alternatively, or in addition, the repeating device 120 may report a plurality of beams 160 of the network device 120 associated with a backhaul beam 170 of the repeating device 130 along with strength of received signals on the beams 160. Thereby, the network device 120 may determine a backhaul beam 170 based on the related strength of received signals for better spatial directivity. In some embodiments, the reported beams 160 may have the highest strength to further increase a channel gain in a spatial domain and thus improve the efficiency of future communications in the communication network 100.

By way of example, in some embodiments, an explicit indication or a combined (or joint) indication with a beam for the access link of the NCR-Fwd may be used. A beam width or beam number for a backhaul link of an NCR (as an example of the repeating device 130) may be reported to a gNB (as an example of the network device 120), same as the NCR-MT.

A dedicated and joint beam index may be defined for both the backhaul beam and the access beam, which may first encode the backhaul beam and then encode the access beam. The beam width may be associated with the beam index. Accordingly, payload may be decided by the beam width of both the backhaul beam and the access beam.

Table 2 shows an example implementation of beam indexes for the joint indication of the backhaul beam and the access beam.

TABLE 2

| Indicated | | | Indicated | | |
|---|---|---|---|---|---|
| Beam | | | Beam | | |
| index | BH beam | AC beam | index | BH beam | AC beam |
| 0 | Off | Off | 0000 | The 1st | The 1st |
| | | | | middle | middle |
| | | | | width | width |
| | | | | beam | beam |
| 1 | On, Omni- | On, Omni- | 0001 | The 1st | The 2nd |
| | directional | directional | | middle | middle |
| | beam | beam | | width | width |
| | | | | beam | beam |
| 00 | Omni- | The 1st | 0010 | The 1st | The 3rd |
| | directional | middle | | middle | middle |
| | beam | width | | width | width |
| | | beam | | beam | beam |
| 01 | Omni- | The 2nd | 0011 | The 1st | The 4th |
| | directional | middle | | middle | middle |
| | beam | width | | width | width |
| | | beam | | beam | beam |
| 10 | Omni- | The 3rd | 0100 | The 2nd | The 1st |
| | directional | middle | | middle | middle |
| | beam | width | | width | width |
| | | beam | | beam | beam |
| 11 | Omni- | The 4th | 0101 | The 2nd | The 2nd |
| | directional | middle | | middle | middle |
| | beam | width | | width | width |
| | | beam | | beam | beam |
| | | | 0110 | The 2nd | The 3rd |
| | | | | middle | middle |
| | | | | width | width |
| | | | | beam | beam |
| | | | 0111 | The 2nd | The 4th |
| | | | | middle | middle |
| | | | | width | width |
| | | | | beam | beam |
| | | | . . . | | |

In some embodiments, the pair information between the backhaul beam and the beam of the gNB may be pre-defined or determined before the combined beam indication is determined. The pair information may include RSRP of each beam pair, or top N gNB beams for each backhaul beam and the related RSRP (where N represents any suitable integer). The NCR-MT may measure the RSRP and reports the measurements.

In some embodiments, the control module 135 and the forwarding module 140 of the repeating device 130 may be near to each other, and correlation exists between the backhaul beam 170 and the control beam 165. However, the backhaul and control beams 170 and 165 may be associated with different panels of antennas, and accordingly the backhaul beam 170 and the control beam 165 may be different. In these embodiments, for example, the network device 120 may use the indication of the control module 165 to indicate a part of information about the backhaul beam 170, and use an indication dedicated to the backhaul beam 170 to indicate a remaining part of the information about the backhaul beam 170. Alternatively, the remaining part of the information may be indicated by the joint indication of the backhaul beam 170 and the access beam 175.

As discussed above, the locations of the network device 120 and the repeating device 130 may be relatively fixed. Accordingly, the channel of the backhaul link 150 between the network device 120 and the repeating device 130 may vary slower. In some embodiments, the indication dedicated to the backhaul beam 170 may be semi-statically transmitted by the network device 120 to the repeating device 130 to reduce the signaling overhead and saving processing and computing resources of the network device 120 and the repeating device 130.

In addition, the indication dedicated to the backhaul beam 170 may be dynamically changed or adjusted to switch to an alternative beam, for example, if a block temporarily occurs between the network device 120 and the repeating device 130. The dynamic change of the backhaul beam 170 may be based on a periodic beam measurement for the backhaul link 150, for example, to track channel variation. Alternatively, or in addition, the dynamic change of the backhaul beam 170 may be based on quality of a channel between the network device 120 and the terminal device 110, for example, to further improve the overall channel gain between the network device 120 and the terminal device 110.

In some embodiments, the network device 120 may maintain a pair of the backhaul beam 170 and a beam 160 of the network device 120. Thus, the network device 120 may need to maintain more than one beam pair which may include one or more pairs of the backhaul beam 170 and the beam 160 of the network device 120 and one or more pars of the control beam 165 and the beam 160 of the network device 120.

In some embodiments, if the indication dedicated to the backhaul beam 170 is transmitted by the network device 120 to the repeating device 130, the indication dedicated to the access beam 175 may be further transmitted to indicate the information about the access beam 175. In some embodiments, the indication dedicated to the access beam may be dynamically transmitted, for example, via downlink control information (DCI). In some embodiments, the indication dedicated to the access beam 175 may be carried via a field related to modulation and coding scheme (MCS) and/or frequency domain resource allocation (FDRA) in the DCI. It may be also possible to reuse any other fields of the DCI to avoid a change of an existing system architecture for backward compatibility, or avoid defining a new DCI format which increases the complexity. In some embodiments, the indication dedicated to the access beam 175 may additionally be semi-statically configured for the repeating device 130.

As discussed above, the location of the terminal device 110 may vary over time due to its mobility. Thus, the channel conditions in the access link 155 between the repeating device 130 and the terminal device 110 may vary faster over time. The dynamic transmission of the indication dedicated to the access beam 175 may fit the time-varying channel conditions, thereby improving the channel gain and further communication efficiency.

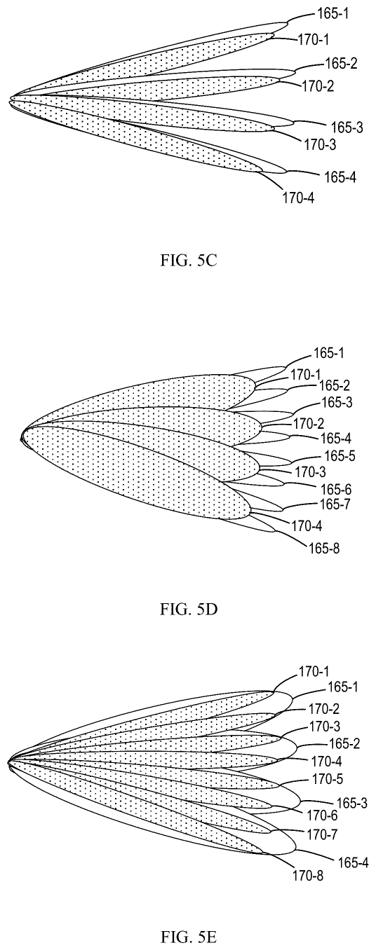

In some embodiments, a backhaul beam may be mapped to a set of control beams, or a set of backhaul beams may be mapped to a control beam. The mapping relationship of a plurality of backhaul beams and a plurality of control beams may be determined in association with different combinations of beam widths of the backhaul and control beams. Some embodiments in this regard will be discussed in the following paragraph with reference FIGS. 5A, 5B, 5C, 5D and 5E. Alternatively, or in addition, the mapping relationship may be predefined or predetermined according to the network plan or capabilities of the repeating device 130.

By way of example, the backhaul beam may be different from that of an NCR-MT (as an example of the control module 135). For example, different panels may be applied for a backhaul link of an NCR-Fwd (as an example of the forwarding module 135) and the NCR-MT. However, the backhaul beam may be partially correlated with that of the NCR-MT. A beam of the NCR-MT beam may also be called an MT beam. For example, in some scenarios, the locations of the NCR-MT and the NCR-Fwd may be near to each other, and therefore the correlation between the BH beam and the MT beam may exist.

A relationship may be defined between the beams of the NCR-Fwd and the NCR-MT, and then the beam of the NCR-MT may be used to indicate part information of the BH beam. The relationship may be predefined or pre-determined according to the network plan and the hardware information or setting, such as an antenna number, a direction of a beam, and/or according to the measurements based on received signals on the NCR-MT and the NCR-Fwd. The NCR-Fwd may have the capability to measure the strength of the received signal. The relationship may be extended to multiple relationships with different combinations of beam widths.

FIGS. 5A, 5B, 5C, 5D and 5E show examples of mapping of the backhaul beams 170 and the control beams 165 according to some embodiments of the present disclosure.

In FIGS. 5A and 5C, one control beam 165-1 . . . 165-4 is mapped to one backhaul beam 170-1 . . . 170-4. In FIG. 5D, a plurality of control beams is mapped to one backhaul beam. As shown, two of the control beams 165-1 . . . 165-8 are mapped to one of the backhaul beams 170-1 . . . 170-4. For example, control beams 165-1 and 165-2 are mapped to the backhaul beam 170-1. If the mapping relationship is one control beam to one BH beam, or multiple control beams to one BH beam, the BH beam may be determined implicitly by the control beam entirely.

In FIG. 5B, more than one BH beam 170-1 . . . 170-4 are mapped to more than one control beam 165-1 . . . 165-4. For example, BH beam 170-1 is mapped to control beams 165-1 and 165-2, control beam 165-2 is mapped to BH beams 170-1 and 170-2. In FIG. 5E, two of the BH beams 170-1 . . . 170-8 are mapped to one control beam 165-1 . . . 165-4. For example, BH beams 170-1 and 170-2 are mapped to control beam 165-1. If the mapping relationship is multiple BH beams to one control beam, or multiple BH beams to multiple control beams, then part information of the BH beam may be determined by the control beam. Other information may be separately indicated or jointly encoded with the beam index of the access beam.

In some embodiments, if the level of the correlation between backhaul beam 170 and the control beam 165 is lower than another predefined threshold level, for example, the backhaul beam 170 and the control beam 165 may be different due to separate positioning of the forwarding module 140 and the control module 135. In these embodiments, the network device 120 may transmit an indication dedicated to the backhaul beam 170 to the repeating device 130 to indicate at least partially the backhaul beam 170. For example, some information about the backhaul beam may be indicated by this dedicated indication, some other information may be indicated by a joint indication of the backhaul and access beams.

By way of example, in some embodiments, the backhaul beam may be totally different from that of the NCR-MT (as an example of the control module 135), or totally independent with that of the NCR-MT, for example, in the scenario that locations of the NCR-MT and the NCR-Fwd are different and thus no correlation exists between the channels or beams of the two links.

The combined or separate beam indication may be used for the beam indication of the BH beam and the AC beam. The separate or dedicated indication for the BH beam may comprise a semi-static indication and a dynamic state indication to switch to an alternative beam. A periodic beam measurement may be applied for the backhaul link to track the channel variation. More than one beam pair may be maintained in a gNB (as an example of the network device 120). The dedicated indication of the AC beam may comprise a dynamic indication via DCI by reusing the field such as MCS and/or FDRA to indicate the AC beam.

In some embodiments, the indications for the BH and AC beams may have some time-domain signaling characteristic. For example, the indication for a receiving (Rx) beam of the NCR-MT may have a semi-static configuration (static channel conditions) and an aperiodic trigger (blockage). The indication for the BH beam of the NCR-Fwd may have a semi-static configuration (static channel conditions) and an aperiodic trigger (blockage), as well as a dynamic configuration for adjusting the whole channel between a gNB (as an example of the network device 120) and a UE (as an example of the terminal device 110). The indication for the AC beam of the NCR-Fwd may have a dynamic configuration.

In some embodiments, the network device 120 may determine effective time of the backhaul and access beams for communications with the repeating device 130. The effective time may be determined based on time indicated by the repeating device 130. The indicated time may be associated with a processing delay or transmission delay of the repeating device 130.

For example, the indicated time may be associated with decoding of at least one indication of the at least one of the backhaul or access beam. After the beam indication is received, the repeating device 130 may decode it to obtain the information about the backhaul and/or access beam. Accordingly, the effective time may be associated with the decoding time.

The indicated time may further comprise time of information transmission from the control module 135 to the forwarding module 140 of the repeating device 130. For example, after the control module 135 receives and decodes the indication of the backhaul and/or access beam, the control module 135 may transmit the decoded information to the forwarding module 140 if the two modules 135 and 140 are apart or separate from each other.

Based on the decoded information, the forwarding module 140 may switch to the indicated backhaul and/or access beam. Accordingly, the indicated time may further be associated with switching of the backhaul and access beams.

By way of example, in some embodiments, the effective time of the indicated beam may consider time for decoding the indication of an NCR-MT (as an example of the control module 135), time for information transmission from the NCR-MT to an NCR-Fwd (as an example of the forwarding module 140). If the time for information transmission can be ignorable, for example, in the scenario that the two modules are collocated, then this time may be excluded in the consideration of the effective time.

The effective time may consider beam switching time of the NCR-Fwd such as a beam switch of the BH beams (for example, including switching a beam width only, switching a direction only, and/or switching both a beam width and a direction), and a beam switch of the AC beams (for example, including switching a beam width only, switching a direction only, and/or switching both a beam width and a direction). In some embodiments, the beam switching time may be selected as a maximum time of a time for switching a beam width only, a time for switching a direction only, and a time for switching both a beam width and a direction, or the beam switching time may be associated with the maximum time.

The switching time may depend on whether to support simultaneous beam switching of the BH beam and the AC beam. If the simultaneous beam switching is supported, max(t_{AC}, t_{BH}) may be used for effective time definition, where t_{AC} represents the switching time of the AC beam, t_{BH} represents the switching time of the BH beam, and max( ) represents a function of calculating a maximum. If the simultaneous beam switching is not supported, sum(t_{AC}, t_{BH}) may be used for effective time definition, where sum( ) represents a function of calculating a sum.

t_{AC} may be 0 if the AC beam doesn't switch; otherwise, it may be the switching time of the AC beam or the time for switching a beam width only, switching a direction only, and/or switching both a beam width and a direction. t_{BH} may be 0 if the BH beam doesn't switch; otherwise, it may be the switching time of the BH beam or the time for switching a beam width only, switching a direction only, and/or switching both a beam width and a direction.

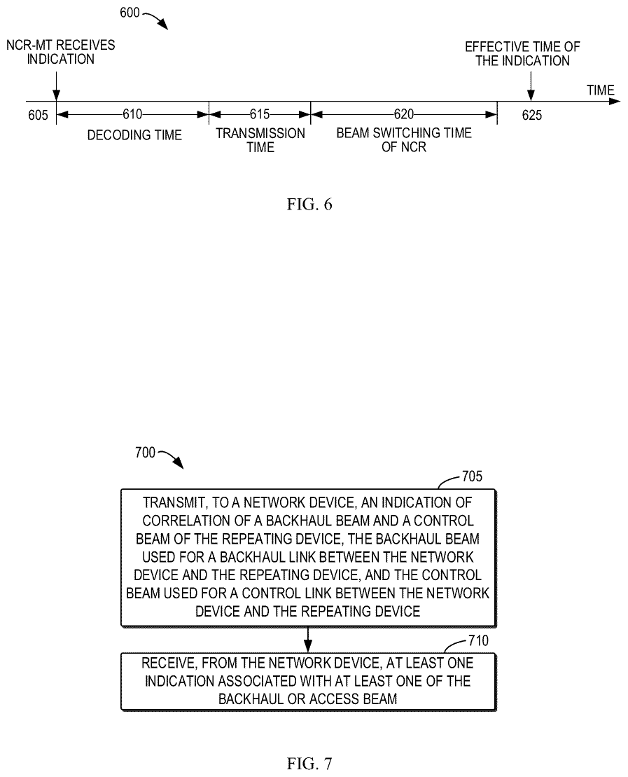

FIG. 6 shows a process 600 of determining the effective time of the indicated beam according to some embodiments of the present disclosure.

As shown in FIG. 6, the NCR-MT may receive the indication at a time 605. After a decoding time 610 of the indication at the NCR-MT, a transmission time 615 from the NCR-MT to the NCR-Fwd and a beam switching time 620 of an NCR (as an example of the repeating device 130), the effective time of the indication may be determined to be a time point. The listed three times may be reported by the NCR first as capabilities. If the transmission time is ignorable, the NCR may not report this information or report it as “0”.

FIG. 7 shows a beam indication method 700 according to some embodiments of the present disclosure. The method 700 can be implemented by the repeating device 130. For the purposes of discussion, the method 700 will be discussed from the perspective of the repeating device 130 with reference to FIG. 1.

At block 705, the repeating device 130 transmits to the network device 120 an indication of correlation of the backhaul beam 170 and the control beam 165 of the repeating device 130. The backhaul beam 170 may be used for the backhaul link 150 between the network device 120 and the repeating device 130, and the control beam 165 may be used for the control link 145 between the network device 120 and the repeating device 130.

The correlation of the backhaul and control beams 170 and 165 may be reported by the repeating device 130 as capabilities. The correlation may be predefined or pre-determined according to the network plan and the hardware information or setting, such as an antenna number, a direction of a beam, and/or according to the measurements based on received signals on the control and forwarding modules 135 and 140.

At block 710, the repeating device 130 receives from the network device 120 at least one indication associated with at least one of the backhaul or access beam. In some embodiments, the indication may be transmitted by the network device 120 based on the correlation of the backhaul and control beams 170 and 165 according to the predefinition.

For example, if a level of the correlation is equal to or higher than a threshold level (such as a middle level or a high level), the repeating device 130 may receive from the network device 120 an indication of the control beam that may at least partially indicate the backhaul beam. In this example, after the repeating device 130 receives the indication of the control beam 165, the repeating device 130 may determine, based on the correlation of the backhaul beam 170 and the control beam 165, that the indication of the control beam 165 may at least partially indicate the backhaul beam 170.

The backhaul and control beams 170 and 165 may have any suitable mapping relationship which may depend on the relative locations of the forwarding and control modules 140 and 135 and/or the hardware settings of the two modules 140 and 135. In some embodiments, the backhaul beam 170 may be mapped to the control beam 165 based on at least one of: the number of antennas to form the backhaul and control beams, directions of the backhaul and control beams, widths of the backhaul and control beams, strength of received signals in the backhaul and control links, or locations of antennas to form the backhaul and control beams.

In some embodiments, if the forwarding and control modules 140 and 135 are collocated, the backhaul and control beams 170 and 165 may be the same. In some embodiments, the backhaul and control beams 170 and 165 may be associated with different panels of antennas, for example, although the forwarding and control modules 140 and 135 are collocated. In this example, some information of the backhaul beam 170 may be partially indicated by the control beam 165 while other information of the backhaul beam 170 may be indicated by a dedicated indication of the backhaul beam 170 or a joint indication of the backhaul and access beams 170 and 175.

In some embodiments, one backhaul beam 170 may be mapped to a set of control beams (or one or more control beams), and/or a set of backhaul beams (or one or more backhaul beams) may be mapped to one control beam, for example, depending on the widths and directions of the backhaul and control beams.

In some embodiments, the repeating device 130 may receive from the network device 120 an indication dedicated to the backhaul beam 170 that may at least partially indicate the backhaul beam 170. For example, in the embodiments where the indication of the control beam 165 indicates a part of information about the backhaul beam 170, the repeating device 130 may receive from the network device 120 the indication dedicated of the backhaul beam 170 that indicates a remaining part of the information about the backhaul beam 170. Alternatively, or in addition, the dedicated indication of the backhaul beam 170 may be used together with the joint indication of the backhaul and access beams 170 and 175 to indicate the information about the backhaul beam 170.

In some embodiments, the dedicated indication of the backhaul beam 170 may be semi-statically transmitted by the network device 120 since the locations of the network device 120 and the repeating device 130 are relatively fixed. In some embodiments, the dedicated indication of the backhaul beam 170 may be dynamically changed based on at least one of a periodic beam measurement for the backhaul link 150, or quality of a channel between the network device 120 and the terminal device 110, to cope with the changed channel conditions due to moving blocks in the backhaul link 150.

In some embodiments, the repeating device 130 may receive from the network device 120 an indication dedicated to the access beam. In some embodiments, the indication dedicated to the access beam may be dynamically received by the repeating device 130 via DCI. In some embodiments, the indication dedicated to the access beam may be carried via a field related to MCS and/or FDRA in the DCI. The dynamic transmission of the dedicated indication of the access beam 175 may fit the time-varying channel conditions in the access link 155 due to mobility of the terminal device 110.

In some embodiments, the indication dedicated to the access beam 175 may comprise a first beam index associated with at least one of: a first beam width of the access beam 175, the number of access beams with the first beam width, or a channel associated with the access beam 175.

For example, if the first beam width of the access beam 175 is broader, or the number of access beams with the same first beam width is smaller, the first beam index may have less bits. If the first beam width is narrower, or the number of access beams with the same first beam width is larger, the first beam index may have more bits.

In some embodiments, the repeating device 130 may receive from the network device 120 an indication of a beam width for an access beam to be used. Based on this indication, the repeating device 130 may determine a configuration of the first beam index such as a bit length and decode the first beam index accordingly.

In the embodiments where the first beam index is associated with a channel carried in the access link 155, the repeating device 130 may associate the first beam index with the channel to be monitored or detected and further decode the first beam index according to predefined rules associated with the channel. For example, a common channel such as PBCH may be associated with an omni-directional beam or a middle beam, and thus the first beam index associated with the common channel may have less bits. A dedicated channel such as PDSCH and PUSCH channels may be associated with a middle beam or a narrow beam, and thus the first beam index associated with a dedicated channel may need more bits.

In some embodiments, the first beam index may comprise a predetermined number of bits to occupy a fixed payload for simplifying the processing or operations of both a transmitter and a receiver. In some embodiments, valid bits within the predetermined number of bits may be determined based on the first beam width of the access beam 175 and/or the number of access beams with the same first beam width. If the first beam width is broader, or the number of access beams with the same first beam width is smaller, the valid bits may be less. If the first beam width is narrower, or the number of access beams with the same first beam width is larger, the valid bits may be more.

In some embodiments, the access beam 175 may be indicated to be an omni-directional beam. In these embodiments, the indication dedicated to the access beam 175 may further indicate an on-off state of the access link 155 to further reducing the signaling overhead and thus improving the network efficiency.

In some embodiments, the repeating device 130 may receive from the network device 120 a joint indication of the backhaul and access beams 170 and 175 that may indicate both the backhaul and access beams 170 and 175. In some embodiments, the joint indication of the backhaul and access beams 170 and 175 may comprise a second beam index associated with at least one of: a first beam width of the access beam and a second beam width of the backhaul beam, the number of access beams with the first beam width and the number of backhaul beams with the second beam width, or a channel associated with the backhaul and access beams.

In some embodiments, the second beam index may comprise a first set of bits for the backhaul beam 170 and a second set of bits for the access beam 175 that follows the first set of bits for the backhaul beam 170. Considering that the locations of the network device 120 and the repeating device 130 may be relatively fixed, a value of the joint indication may vary slower over time. In some embodiments, the repeating device 130 may receive from the network device 120 an indication of a difference between a current value and a previous value of the joint indication to further reduce signaling overhead.

Some pairs of the backhaul beams 170 of the repeating device 130 and the beams 160 of the network device 120 may be invalid, for example, due to the network plan and/or capabilities of the devices 120 and 130. In some embodiments, the repeating device 130 may determine a valid pair of a backhaul beam of the repeating device 130 and a beam of the network device 120. The joint indication of the backhaul and access beams 170 and 175 may be determined by the network device 120 based on the valid pair, for example, by excluding the backhaul beam of invalid pairs of the beams 170 and 160.

In some embodiments, the repeating device 130 may transmit to the network device 120 information about a pair of the backhaul beam 170 and the beam 160 of the network device 120. The information may be associated with at least one of: strength of received signals on a plurality of pairs of backhaul beams 170 of the repeating device 130 and beams 160 of the network device 120, or a plurality of beams 160 of the network device 120 associated with a backhaul beam 170 of the repeating device 130 along with strength of received signals on the plurality of beams 160 of the network device 120.

In some embodiments, the repeating device 130 may transmit to the network device 120 an indication of time associated with at least one of: decoding of at least one indication of the at least one of the backhaul or access beam 170 or 175, information transmission from the control module 135 to the forwarding module 140 of the repeating device 130, or switching of the backhaul and access beams 170 and 175. Based on the time indicated by the repeating device 130, the network device 120 may determine and further indicate the effective time of the backhaul and/or access beam 170 and/or 175 to the repeating device 130.

All operations and features related to the repeating device 130 as described above with reference to FIGS. 1 to 6 are likewise applicable to the method 700 of the repeating device 130 and have similar effects. For the purposes of simplification, the details will be omitted.

A beam indication scheme for a repeating device according to some embodiments of the present disclosure has been discussed above with reference to FIGS. 1-7. This scheme defines the signaling and process for beam indication or QCL information indication for the repeating device. Based on the signaling, the backhaul and/or access beam may be determined uniquely, and some misalignment between the network device and the terminal device may be avoided. Such a beam indication may improve the efficiency of the beam management (BM) based on a repeating device.

As another part of the beam management, both a repeating device and a terminal device may need to perform beam scanning to find a better or best beam for future communications. For example, the repeating device may detect a synchronization signal block (SSB) or system information block (SIB) from a network device, and then both the repeating device and the network device may determine an initial pair of beams for communications. The repeating device may forward the SSB or other common signals from the network device to the terminal device such that the terminal device may determine an initial beam to perform an initial access (IA).

Moreover, the repeating device may further perform finer beam management (BM) based on channel state information reference signal (CSI-RS) resources configured by the network device. For example, the repeating device may measure RSRP per CSI-RS resource and find the better or best Rx beam (such as the BH beam or MT beam).

Accordingly, the network device may determine and further configure the beams of the network device and the repeating device.

If the terminal device has completed the initial access (IA), the gNB may send a CSI-RS configuration via the repeating device to the terminal device for further finer beam training of the terminal device. Then, the terminal device may measure RSRP per CSI-RS resource and find the better or best Rx beam. The network device may configure the beams between the repeating device and the terminal device. The Tx beam for DL may be captured by “downlink spatial domain transmission filter”.

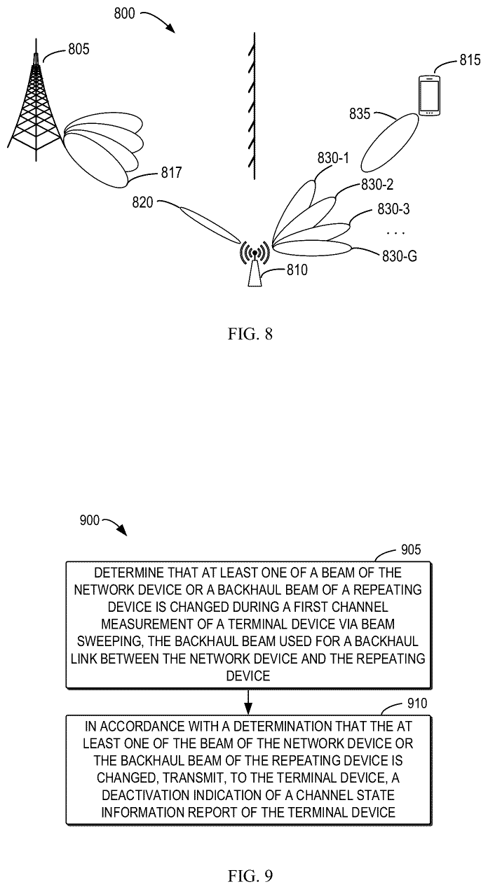

After the repeating device completes the finer beam training, the network device may switch to a narrower beam. If the terminal device has not completed the finer beam training yet, the group of CSI-RS related measurements of the terminal device may have different baselines. An example of such a situation will be discussed below with reference to FIG. 8.

FIG. 8 shows an example process 800 of finer beam training according to some embodiments of the present disclosure. In this example, a gNB 805 acts as a network device, an NCR 810 acts as a repeating device, and a UE 815 acts as a terminal device.

As shown in FIG. 8, the gNB 805 may transmit CSI-RSs to the NCR 810 via a beam 817 of the gNB 805 and a beam 820 of the NCR 810 for finer beam training. The beams 817 and 820 may be determined based on SSB or SIB detection of the NCR 810. The CSI-RSs may occupy a plurality of CSI-RS resources. The NCR 810 may forward the CSI-RSs to the UE 815 via beams 830-1, 830-2, 830-3 . . . 830-G of the NCR 810 and a beam 835 of the UE 815 where G represents any suitable integer. Each of the CSI-RSs may be transmitted using one of the CSI-RS resources via one of the beams 830-1, 830-2, 830-3 . . . 830-G.

In this example, the finer beam training of the NCR 810 is finished earlier, and the gNB 805 may switch to a narrower beam to continue the transmission of the CSI-RSs. At this time, the UE 815 may have already performed the CSI-RS measurements for the beams 830-1 and 830-2, but not performed the CSI-RS measurement for the beam 830-3 yet. In this situation, the UE 815 may perform measurements on the beams 830-3 to 830-G based on the CSI-RS transmitted by the gNB 805 using the switched narrower beam. Thus, the measurements for the beams 830-1 and 830-2 and the beams 830-3 to 830-G may be not compared with each other since they are derived based on different baselines that are related to different beam widths. A similar situation may occur if the NCR 810 changes a beam width of the beam 820 after the finer beam training while the UE 825 is still performing the CSI-RS measurement.

In addition, before and after finer BM of the repeating device, different beam widths may be used by the network device and/or the repeating device for transmitting BM signals to the terminal device. Thus, there are multiple Quasi-co-located (QCL) assumptions. For example, considering the gNB Tx beam (as an example of the Tx beam of the network device) and the NCR TX beam (as an example of the Tx beam of the repeating device), an SSB and a CSI-RS for BM may use QCL type C or QCL type D, and a CSI-RS for BM and a DMRS may use QCL type D.

Table 3 shows different beam widths before and after finer beam management (BM).

TABLE 3

| No. | gNB Tx beam | NCR Tx beam | Usage |
|---|---|---|---|
| (1) | Wide beam | — | SSB |
| (2) | Narrow beam | — | CI-RS for BM |
| (3) | Wide beam | Wide beam | SSB |
| | | | (after IA of NCR, before finer |
| | | | BM of NCR) |
| (4) | Narrow beam | Wide beam | SSB |
| | | | (after finer BM of NCR) |
| (5) | Wide beam | Narrow beam | CSI-RS |
| | | | (before finer BM of NCR) |
| (6) | Narrow beam | Narrow beam | CSI-RS |
| | | | (after finer BM of NCR) |

As shown in Table 3, the beam combinations (1) and (2) may follow the QCL type C assumption before the finer BM of both the NCR and the UE. The beam combinations (3) and (5) and the beam combinations (4) and (6) both may follow the QCL type C assumption. However, the beam combinations (3) and (4) and the beam combinations (5) and (6) may not follow the QCL type D assumption but follow the QCL type C assumption instead.

In view of the above, there is a need to update a CSI-RS configuration to the terminal device if a beam width of the network device and/or the repeating device changes.

Some embodiments of the present disclosure provide a dynamic deactivation scheme of CSI-RS reporting for a terminal device. With the scheme, if a beam of the network device and/or a backhaul beam of a repeating device is changed during a channel measurement (referred to as a first channel measurement) of a terminal device via beam sweeping, the network device transmits to the terminal device a deactivation indication of a CSI report of the terminal device. The terminal device will cease the CSI report after receiving the deactivation indication.

Based on the signaling, the CSI-RS configuration for UE may be updated timely, and a channel estimation error introduced by outdated Quasi-co-located (QCL) assumption may be avoided.

FIG. 9 shows an example method 900 of updating a CSI-RS configuration according to some embodiments of the present disclosure. The method 900 can be implemented by the network device 120. For the purposes of discussion, the method 900 will be discussed from the perspective of the network device 120 with reference to FIG. 1.

At block 905, the network device 120 determines that a beam 160 of the network device and/or a backhaul beam 170 of the repeating device 130 is changed during a first channel measurement of the terminal device 110 via beam sweeping. For example, if the network device 120 decides to switch to another beam, for example, based on the finer BM of the repeating device 130, the network device 120 may determine that the beam 160 will be changed.

In some embodiments, the network device 120 may determine that the backhaul beam 170 is to be changed based on reporting of a switching state of the backhaul beam 170 from the repeating device 130. For example, the repeating device 130 may switch the BH beam 170 actively. The switching state of the backhaul beam 170 may be reported to the network device 120 and may be associated with an index, a width and/or a direction of the backhaul beam 170. After the network device 120 receives the indication of the switch state, the network device 120 may determine that the backhaul beam 170 will be changed.

At block 910, the network device 120 transmits to the terminal device 110 a deactivation indication of a CSI report of the terminal device 110. In some embodiments, the network device 120 may transmit to the terminal device 110 an indication of a time offset for reactivating the CSI report. The indication of the time offset may be transmitted along with or separate from the deactivation indication. The indication may comprise an offset of an index of a reference signal (RS) resource for the first channel measurement of the terminal device 110. Accordingly, the terminal device 110 may know when and/or where to reactivate the CSI report. In some embodiments, the network device 120 may discard a previous CSI report received from the terminal device 110 in a period when the deactivation indication is transmitted to save storage resources.

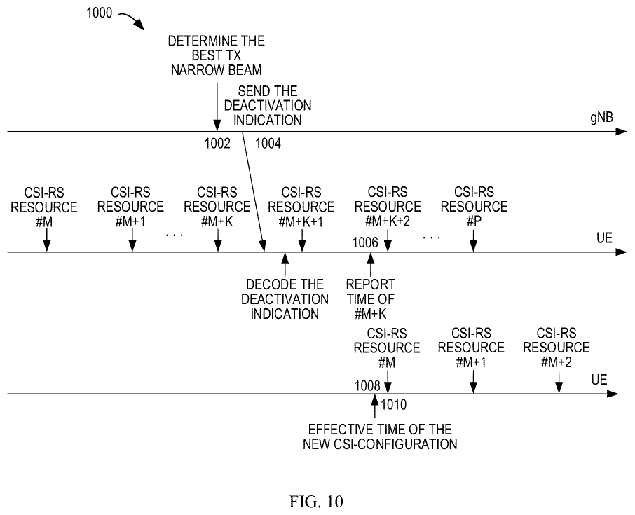

FIG. 10 shows an example process 1000 of updating a configuration of a CSI-RS according to some embodiments of the present disclosure.

In the process 1000, a CSI report may be deactivated related to the latest configuration of a UE (as an example of the terminal device 110). The measurements which haven't been operated, or reported, may discarded by the UE when received the deactivation indication of the CSI report.

As shown in FIG. 10, a gNB (as an example of the network device 120) determines the best Tx narrow beam at a time 1002 and then send the deactivation indication to the UE at a time 1004. Then, the measurement procedure related to the CSI-RS resources #M+K+1 . . . #P may be terminated or cancelled, which includes receiving the signal, decoding the CSI-RS, estimating based on the decoded CSI-RS. The measurement reporting of CSI-RS resources #M+K may be discarded at a time 1006. The measurement related to other CSI-RS resources in a same period may be discarded by the gNB.

For the CSI-RS resources in a resource set, a time offset may be re-configured. As shown in FIG. 10, it may be configured that a next group of CSI-RS measurements is effective at a time 1008. Then, at a time 1010 which corresponds to CSI-RS resource #M+K+2, the UE may reactivate the detection on CSI-RS resource #M. The time offset may be K+2 measurement occasions.

Considering a gNB Tx beam, an NCR Rx beam and an NCR Tx beam, a beam width of an NCR (as an example of the repeating device 130) for a backhaul link may also influence the whole channel characteristics of a UE. Accordingly, the de-activate indication may be sent to the UE when any beam between the gNB and the NCR for BH links changes. If the NCR switches a Rx beam (for example, a BH beam) actively, a switching state (including a beam index, a beam width, or a beam direction, for example) and the effective time of the beam switching may be reported to the gNB. The gNB may de-activate the present measuring procedure and re-configure the CSI-RS according to the received reports.

In some embodiments, the network device 120 may transmit to the repeating device 130 an indication of a relatively long periodicity for reporting strength of received signals on a RS resource for a channel measurement (referred to as a second channel measurement) of the repeating device 130 in a link between the network device 120 and the repeating device 130. The strength of the received signals may be indicated by RSRP, RSSI, and/or any other suitable measure based on other suitable criterion.

For example, the periodicity may be above threshold periodicity such as a number of slots. In this way, the beam between the network device 120 and the repeating device 130 may be changed or adapted to a narrower beam after the terminal device 110 may complete the finer beam training based on wider beams, to further avoid a channel estimation error introduced by outdated QCL assumption.

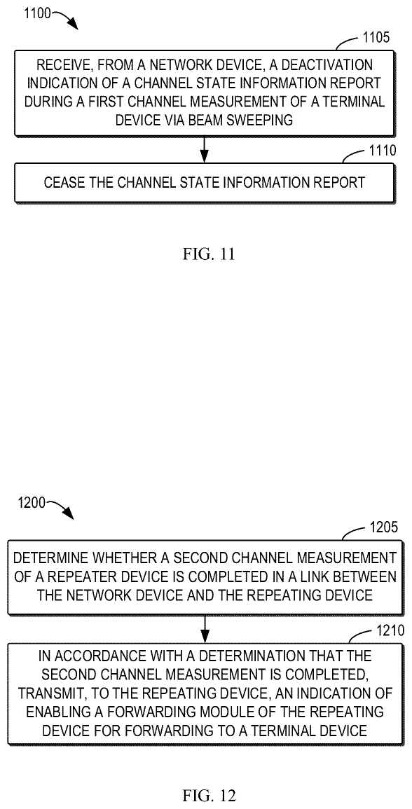

FIG. 11 shows an example method 1100 of updating a CSI-RS configuration according to some embodiments of the present disclosure. The method 1100 can be implemented by the terminal device 110. For the purposes of discussion, the method 1100 will be discussed from the perspective of the terminal device 110 with reference to FIG. 1.

At block 1105, the terminal device 110 receives from the network device 120 a deactivation indication of a CSI report during a first channel measurement of the terminal device 110 via beam sweeping. At block 1110, the terminal device 110 ceases the CSI report.

In some embodiments, the terminal device 110 may receive from the network device 120 an indication of a time offset for reactivating the CSI report. In some embodiments, the indication of the time offset may comprise an offset of an index of a RS resource for the first channel measurement. Based on the time offset, the terminal device 110 may determine when to resume the first channel measurement and the CSI report.

All operations and features related to the terminal device 110 as described above with reference to FIGS. 9 and 10 are likewise applicable to the method 1100 of the terminal device 110 and have similar effects. For the purposes of simplification, the details will be omitted.

The dynamic deactivation of a CSI-RS report of the terminal device may allow the CSI-RS configuration to be updated to the terminal device in real time and further avoid a channel estimation error introduced by outdated QCL assumption.

To avoid a change of the beam width of the network device 120 and/or the repeating device 130 to influence the channel characteristics of the terminal device 110, some embodiments of the present disclosure provide an activation scheme for a forwarding module of the repeating device. With this scheme, if a second channel measurement of the repeater device is completed in a link between the repeater device and a network device, and/or if an indication of enabling a forwarding module of the repeating device is received from the network device, the repeating device enables the forwarding module for forwarding to a terminal device.

In this way, the forwarding module of the repeating device may be switched on after the second channel measurement of the repeater device is finished. The NCR doesn't expect to receive the enabling indication of the forwarding module before completing the second channel measurement. Thus, an invalid channel measurement of the terminal device may be avoided in the case of beam width updating of the network device and/or the repeating device.

FIG. 12 shows an example method 1200 of enabling forwarding operations of the repeating device according to some embodiments of the present disclosure. The method 1200 can be implemented by the network device 120. For the purposes of discussion, the method 1200 will be discussed from the perspective of the network device 120 with reference to FIG. 1.

At block 1205, the network device 120 determines whether a second channel measurement of the repeater device 130 is completed in a link between the network device 120 and the repeating device 130. In some embodiments, the network device 120 may receive from the repeating device 130 a report for the second channel measurement. Based on the reception of the report, the network device 120 may determine that the second channel measurement is completed.

At block 1210, if the second channel measurement is completed, the network device 120 transmits to the repeating device 130 an indication of enabling the forwarding module 140 of the repeating device 130 for forwarding to the terminal device 110. As such, it may be avoided that a first channel measurement of the terminal device is influenced by beam width updating of the network device 120 and/or the repeating device 130.

In some embodiments, the network device 120 may transmit to the repeating device 130 an indication of a RS resource for the second channel measurement. The indicated RS resource may have a smaller offset. The offset may be lower than a threshold offset, such as a number of slots. As such, the finer BM may be started at the repeating device 130 and the terminal device 110 sooner.

In some embodiments, the network device 120 may transmit to the repeating device 130 an indication of a periodicity for reporting strength of received signals (such as RSRP and RSSI) on a RS resource for the second channel measurement. The periodicity may be longer, for example, above a threshold periodicity such as a number of slots, such that the beam between the network device 120 and the repeating device 130 may be changed or adapted to a narrower beam after the terminal device 110 may complete the finer beam training based on wider beams, to further avoid a channel estimation error due to outdated QCL assumption.

In some embodiments, the network device 120 may configure the repeating device 130 with two or more different CSI-RS resource sets. One of CSI-RS resource sets may comprise trigger-state CSI-RS resources with an offset below a threshold. Finer beam training may be completed fast based on this CSI-RS resource set. Another one of CSI-RS resource sets may comprise CSI-RS resources with a longer periodicity. Considering that the network device 120 and the repeating device 130 are relatively stable or static, this CSI-RS resource set may be used by the repeating device 130 for regular beam sweeping and channel tracking, to further reduce the system overhead. These CSI-RS resource sets may have different effective time.

By way of example, in some embodiments, to avoid an invalid channel measurement caused by beam width updating of a gNB (as an example of the network device 120), an NCR (as an example of the repeating device 130) may forward the signal only when the beam management based on CSI-RSs is finished. The NCR may not expect to receive an indication to switch on the forwarding module of an access link before reporting all the RSRP associated with CSI-RS resources in a CSI-RS resource set. A triggered CSI-RS resource with an offset smaller than K slots may be configured for the NCR to save the time for finding the best finer beam. The periodicity for reporting the RSRP of CSI-RS resources for the NCR may be larger than Q slots. K and Q may represent any suitable integers.

In some embodiments, to simplify the beam sweeping operations of the repeating device 130 and the terminal device 110, the network device 120 may determine two beam configurations for the repeating device 130 in beam sweeping (referred to as first beam sweeping) of the repeating device 130 and in beam sweeping (referred to as second beam sweeping) of the terminal device 110. In the first beam sweeping, the network device 120 may configure a fixed Rx beam (a CSI-RS resource set with repetition set as “off”) of the terminal device 110 and a group of Tx beams for the repeating device 130. The group of Tx beams may be configured via a group of beam indexes with a common period and a common slot offset, where each beam index may be configured with a symbol offset. As another example, the group of Tx beams for the repeating device 130 may be configured via a group of beam indexes with a common period and a common symbol offset, where each beam index may be configured with a slot offset. Alternatively, or in addition, the group of Tx beams for the repeating device 130 may be configured via a group of beam indexes with a common period, where each beam index is configured with a symbol offset and a slot offset. The number of beam indexes in the group is decide by the number of access beams of the NCR.

In the second beam sweeping of the terminal device 110, a Tx beam of the repeating device 130 may be fixed. For example, the network device 120 may configure a beam index for the repeating device 130 with a period, a slot offset and a group of symbol offsets where the number of symbol offsets is equal to the number of Rx beams of the terminal device 110. Alternatively, or in addition, the network device 120 may configure a beam index for the repeating device 130 with a period, a symbol offset and a group of slot offsets where the number of slot offsets is equal to the number of Rx beams of the terminal device 110. Alternatively, or in addition, the network device 120 may configure a beam index with a period and a group of offset pair, each pair including a slot offset and a symbol offset (where the number of symbol offsets is equal to the number of Rx beams of the terminal device 110). At the same time, the CSI-RS configuration configured by the network device for the terminal device includes a CSI-RS resource set with repetition set as “ON”.

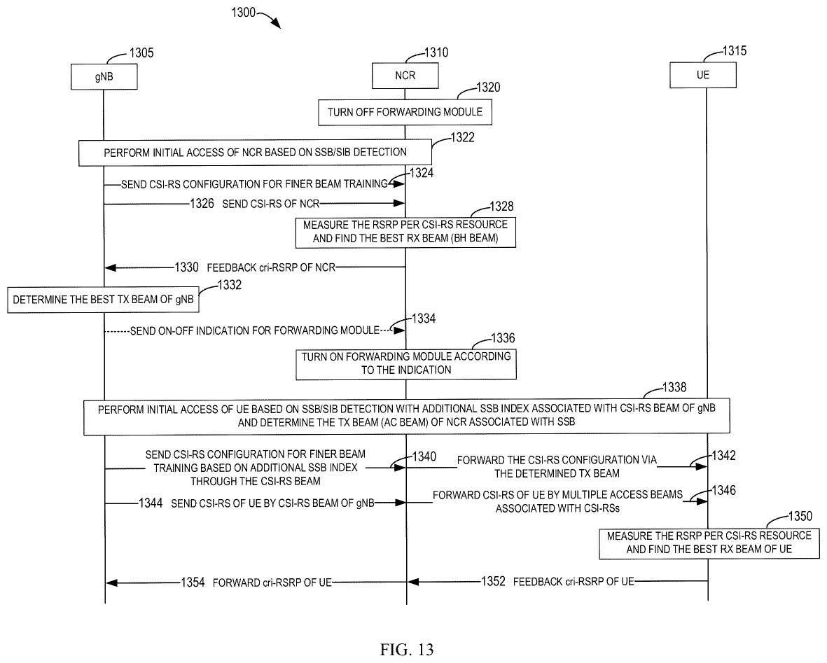

FIG. 13 shows an example process 1300 of enabling the forwarding operations according to some embodiments of the present disclosure. In this example, an gNB 1305 may act as the network device 120, an NCR 1310 may act as the repeating device 130, and a UE 1315 may act as the terminal device 110.

As shown in FIG. 13, at 1320, the NCR 1310 may turn off a forwarding module (as an example of the forwarding module 140). At 1322, the gNB 1305 and the NCR 1310 may perform an initial access of the NCR based on SSB and/or SIB detection. At 1324, the gNB 1305 may send a CSI-RS configuration for finer beam training to the NCR 1310. At 1326, the gNB 1305 may send a CSI-RS of the NCR 1310. At 1328, the NCR 1310 may measure the RSRP per CSI-RS resource and find the best Rx beam (such as a BH beam). At 1330, the NCR 1310 may feed CSI-RS Resource Indicator (cri)-RSRP of the NCR 1310 back. At 1332, the gNB 1305 may determine the best Tx beam of the gNB 1305. At 1334, the gNB 1305 may optionally send an on-off indication for the forwarding module to the NCR 1310. At 1336, the NCR 1310 may turn on forwarding module according to the indication.

At 1338, the gNB 1305 and the UE 1315 may perform an initial access of the UE 1315 based on SSB and/or SIB detection with an additional SSB index associated with a CSI-RS beam of the gNB 1305 and beam sweeping of the NCR 1310, and determine the first Tx beam (such as a first AC beam) of the NCR 1310 associated with SSB. At 1340, the gNB 1305 may send a CSI-RS configuration for finer beam training through the CSI-RS beam to the UE 1315. At 1342, the NCR 1310 may forward the CSI-RS configuration to the UE 1315 via the Tx beam determined in the initial access. At 1344, the gNB 1305 may send a CSI-RS of the UE 1315 by the CSI-RS beam of the gNB 1305 to the NCR 1310. At 1346, the NCR 1310 may forward the CSI-RS of the UE 1315 by multiple second access beams associated with CSI-RSs to the UE 1315. At 1350, the UE 1315 may measure the RSRP per CSI-RS resource and find the best Rx beam of the UE 1315. At 1352, the UE 1315 may feed cri-RSRP of the UE 1315 back. At 1354, the NCR 1310 may forward the cri-RSRP of the UE 1315 to the gNB 1305. Based on the received csi-RSRP of the UE 1315, the gNB 1305 determines the best second access beam of the NCR 1310, and send the related indication to the NCR 1310.

FIG. 14 shows an example method 1400 of enabling the forwarding operations of the repeating device according to some embodiments of the present disclosure. The method 1400 can be implemented by the repeating device 130. For the purposes of discussion, the method 1400 will be discussed from the perspective of the repeating device 130 with reference to FIG. 1.

At block 1405, the repeating device 130 determines that at least one following condition is met: a condition that second channel measurement of the repeater device is completed in a link between the repeater device and a network device, and/or a condition that an indication of enabling a forwarding module of the repeating device is received from the network device. If at least one condition is met, at block 1410, the repeating device 130 enables the forwarding module 140 for forwarding to the terminal device 110.

In some embodiments, the repeating device 130 may transmit to the network device 120 a report for the second channel measurement to inform of the completion of the second channel measurement. Accordingly, the network device 120 may send the indication of enabling the forwarding module 140.

In some embodiments, the repeating device 130 may receive from the network device 120 an indication of a RS resource for the second channel measurement. The indicated RS resource may have a smaller offset. The offset may be lower than a threshold offset, such as a number of slots. As such, the finer BM may be started at the repeating device 130 and the terminal device 110 sooner.

In some embodiments, the repeating device 130 may receive from the network device 120 an indication of a periodicity for reporting strength of received signals on a reference signal resource for the second channel measurement. The periodicity may be longer, for example, above a threshold periodicity such as a number of slots, to extend the procedure of the finer beam training at the repeating device 130.

All operations and features related to the repeating device 130 as described above with reference to FIGS. 12 and 13 are likewise applicable to the method 1400 of the repeating device 130 and have similar effects. For the purposes of simplification, the details will be omitted.

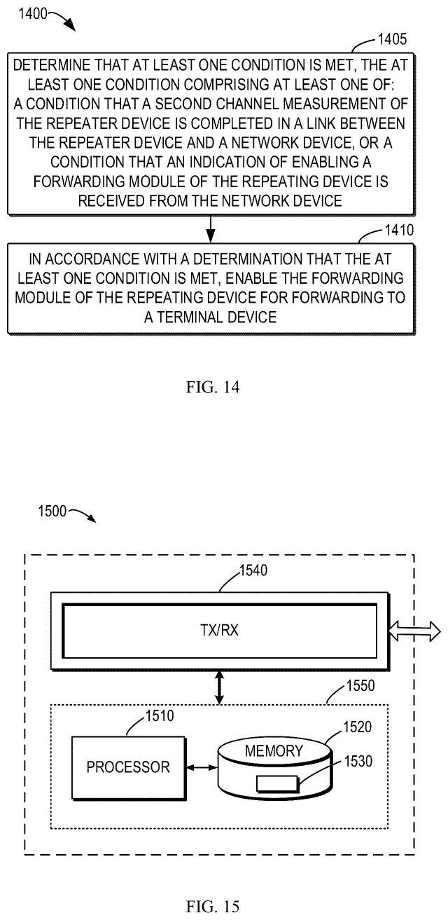

FIG. 15 is a simplified block diagram of a device 1500 that is suitable for implementing embodiments of the present disclosure. The device 1500 can be considered as a further example implementation of the terminal device 110, the network device 120, or the repeating device 130 as shown in FIG. 1. Accordingly, the device 1500 can be implemented at or as at least a part of the terminal device 110, the network device 120, or the repeating device 130.

As shown, the device 1500 includes a processor 1510, a memory 1520 coupled to the processor 1510, a suitable transmitter (TX)/receiver (RX) 1540 coupled to the processor 1510, and a communication interface coupled to the TX/RX 1540. The memory 1510 stores at least a part of a program 1530. The TX/RX 1540 is for bidirectional communications. The TX/RX 1540 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1530 is assumed to include program instructions that, when executed by the associated processor 1510, enable the device 1500 to operate in accordance with the embodiments of the present disclosure, as discussed herein with reference to FIGS. 1 to 14. The embodiments herein may be implemented by computer software executable by the processor 1510 of the device 1500, or by hardware, or by a combination of software and hardware. The processor 1510 may be configured to implement various embodiments of the present disclosure. Furthermore, a combination of the processor 1510 and memory 1520 may form processing means 1550 adapted to implement various embodiments of the present disclosure.

The memory 1520 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1520 is shown in the device 1500, there may be several physically distinct memory modules in the device 1500. The processor 1510 may be of any type suitable to the local technical network, and may include one or more of general purpose computers, special purpose computers, microprocessors, digital signal processors (DSPs) and processors based on multicore processor architecture, as non-limiting examples. The device 1500 may have multiple processors, such as an application specific integrated circuit chip that is slaved in time to a clock which synchronizes the main processor.

In some embodiments, the device 1500 may comprise a circuitry configured to perform a process or method as described above with reference to FIGS. 1 to 14. The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory (ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure provide the following solutions.

In one solution, a method of communication comprises: at a network device, receiving, from a repeating device, an indication of correlation of a backhaul beam and a control beam of the repeating device, the backhaul beam used for a backhaul link between the network device and the repeating device, and the control beam used for a control link between the network device and the repeating device; and indicating, to the repeating device, at least one of the backhaul or access beam.

In some embodiments, indicating the at least one of the backhaul or access beam comprises: in response to a level of the correlation being equal to or higher than a threshold level, transmitting, to the repeating device, an indication of the control beam to at least partially indicate the backhaul beam.

In some embodiments, the backhaul beam is mapped to the control beam based on at least one of: the number of antennas to form the backhaul and control beams, directions of the backhaul and control beams, widths of the backhaul and control beams, strength of received signals in the backhaul and control links, or locations of antennas to form the backhaul and control beams.

In some embodiments, the backhaul and control beams are associated with different panels of antennas.

In some embodiments, the backhaul beam is mapped to a set of control beams, the set of control beams comprising the control beam, or a set of backhaul beams is mapped to the control beam, the set of backhaul beams comprising the backhaul beam.

In some embodiments, the indication of the control beam indicates a part of information about the backhaul beam, and indicating the at least one of the backhaul or access beam further comprises: transmitting, to the repeating device, an indication dedicated to the backhaul beam to indicate a remaining part of the information about the backhaul beam.

In some embodiments, indicating the at least one of the backhaul or access beam comprises: transmitting, to the repeating device, an indication dedicated to the backhaul beam to at least partially indicate the backhaul beam.

In some embodiments, the indication dedicated to the backhaul beam is semi-statically transmitted.

In some embodiments, the indication dedicated to the backhaul beam is dynamically changed based on at least one of a periodic beam measurement for the backhaul link, or quality of a channel between the network device and the terminal device.

In some embodiments, the method further comprises maintaining a pair of the backhaul beam and a beam of the network.

In some embodiments, the method further comprises transmitting, to the repeating device, an indication dedicated to the access beam.

In some embodiments, the indication dedicated to the access beam is dynamically transmitted via downlink control information.

In some embodiments, the indication dedicated to the access beam is carried via a field related to modulation and coding scheme and/or frequency domain resource allocation in the downlink control information.

In some embodiments, the indication dedicated to the access beam comprises a first beam index associated with at least one of: a first beam width of the access beam, the number of access beams with the first beam width, or a channel associated with the access beam.

In some embodiments, the first beam index comprises a predetermined number of bits.

In some embodiments, valid bits within the predetermined number of bits are determined based on the first beam width of the access beam.

In some embodiments, the access beam is indicated to be an omni-directional beam, and the indication dedicated to the access beam further indicates an on-off state of the access link.

In some embodiments, indicating the at least one of the backhaul or access beam comprises: transmitting, to the repeating device, a joint indication of the backhaul and access beams to indicate both the backhaul and access beams.

In some embodiments, the joint indication of the backhaul and access beams comprises a second beam index associated with at least one of: a first beam width of the access beam and a second beam width of the backhaul beam, the number of access beams with the first beam width and the number of backhaul beams with the second beam width, or a channel associated with the backhaul and access beams.

In some embodiments, the second beam index comprises a first set of bits for the backhaul beam and a second set of bits for the access beam, the second set of bits following the first set of bits.

In some embodiments, the method further comprises determining a valid pair of a backhaul beam of the repeating device and a beam of the network device, wherein the joint indication of the backhaul and access beams is determined based on the valid pair.

In some embodiments, the method further comprises receiving, from the repeating device, information about a pair of the backhaul beam of the repeating device and the beam of the network device, the information being associated with at least one of: strength of received signals on a plurality of pairs of backhaul beams of the repeating device and beams of the network device, or a plurality of beams of the network device associated with a backhaul beam of the repeating device, and strength of received signals on the plurality of beams of the network device.

In some embodiments, the method further comprises receiving, from the repeating device, an indication of time associated with at least one of: decoding of at least one indication of the at least one of the backhaul or access beam, information transmission from a control module to a forwarding module of the repeating device, or switching of the backhaul and access beams; and determining effective time of the backhaul and access beams based on the indication of the time.

In one solution, a method of communication comprises: at a network device, determining that at least one of a beam of the network device or a backhaul beam of a repeating device is changed during a first channel measurement of a terminal device via beam sweeping, the backhaul beam used for a backhaul link between the network device and the repeating device; and in accordance with a determination that the at least one of the beam of the network device or the backhaul beam of the repeating device is changed, transmitting, to the terminal device, a deactivation indication of a channel state information report of the terminal device.

In some embodiments, the method further comprises receiving, from the repeating device, an indication of a switching state of the backhaul beam, the switching state being associated with at least one of an index, a width or a direction of the backhaul beam, wherein determining that the at least one of the beam of the network device or the backhaul beam of the repeating device is changed comprises: determining, based on the switching state of the backhaul beam, that the backhaul beam is changed.

In some embodiments, the method further comprises transmitting, to the terminal device, an indication of a time offset for reactivating the channel state information report.

In some embodiments, the indication of the time offset comprises an offset of an index of a reference signal resource for the first channel measurement.

In some embodiments, the method further comprises discarding a previous channel state information report received from the terminal device in a period, wherein the deactivation indication is transmitted in the period.

In some embodiments, the method further comprises transmitting, to the repeating device, an indication of periodicity for reporting strength of received signals on a reference signal resource for a second channel measurement of the repeating device in a link between the network device and the repeating device, the periodicity being above threshold periodicity.

In one solution, a method of communication comprises: at a network device, determining whether a second channel measurement of a repeater device is completed in a link between the network device and the repeating device; and in accordance with a determination that the second channel measurement is completed, transmitting, to the repeating device, an indication of enabling a forwarding module of the repeating device for forwarding to a terminal device.

In some embodiments, the method further comprises transmitting, to the repeating device, an indication of a reference signal resource for the second channel measurement, the reference signal resource having an offset below a threshold offset.

In some embodiments, the method further comprises transmitting, to the repeating device, an indication of periodicity for reporting strength of received signals on a reference signal resource for the second channel measurement, the periodicity being above threshold periodicity.

In some embodiments, the method further comprises receiving, from the repeating device, a report for the second channel measurement; and determining whether the second channel measurement is completed comprises: in response to receiving the report, determining that the second channel measurement is completed.

In one solution, a method of communication comprises: at a repeating device, transmitting, to a network device, an indication of correlation of a backhaul beam and a control beam of the repeating device, the backhaul beam used for a backhaul link between the network device and the repeating device, and the control beam used for a control link between the network device and the repeating device; and receiving, from the network device, at least one indication associated with at least one of the backhaul or access beam.

In some embodiments, receiving the at least one indication comprises: in response to a level of the correlation being equal to or higher than a threshold level, receiving, from the network device, an indication of the control beam, the indication of the control beam at least partially indicating the backhaul beam.

In some embodiments, the backhaul beam is mapped to the control beam based on at least one of: the number of antennas to form the backhaul and control beams, directions of the backhaul and control beams, widths of the backhaul and control beams, strength of received signals in the backhaul and control links, or locations of antennas to form the backhaul and control beams.

In some embodiments, the backhaul and control beams are associated with different panels of antennas.

In some embodiments, the backhaul beam is mapped to a set of control beams, the set of control beams comprising the control beam, or a set of backhaul beams is mapped to the control beam, the set of backhaul beams comprising the backhaul beam.

In some embodiments, the indication of the control beam indicates a part of information about the backhaul beam, and receiving the at least one indication further comprises: receiving, from the network device, an indication dedicated to the backhaul beam, the indication dedicated to the backhaul beam indicating a remaining part of the information about the backhaul beam.

In some embodiments, receiving the at least one indication comprises: receiving, from the network device, an indication dedicated to the backhaul beam, the indication dedicated to the backhaul beam at least partially indicating the backhaul beam.

In some embodiments, the indication dedicated to the backhaul beam is semi-statically transmitted.

In some embodiments, the indication dedicated to the backhaul beam is dynamically changed based on at least one of a periodic beam measurement for the backhaul link, or quality of a channel between the network device and the terminal device.

In some embodiments, the method further comprises receiving, from the network device, an indication dedicated to the access beam.

In some embodiments, the indication dedicated to the access beam is dynamically received via downlink control information.

In some embodiments, the indication dedicated to the access beam is carried via a field related to modulation and coding scheme and/or frequency domain resource allocation in the downlink control information.

In some embodiments, the indication dedicated to the access beam comprises a first beam index associated with at least one of: a first beam width of the access beam, the number of access beams with the first beam width, or a channel associated with the access beam.

In some embodiments, the first beam index comprises a predetermined number of bits.

In some embodiments, valid bits within the predetermined number of bits are determined based on the first beam width of the access beam.

In some embodiments, the access beam is indicated to be an omni-directional beam, and the indication dedicated to the access beam further indicates an on-off state of the access link.

In some embodiments, receiving the at least one indication comprises: receiving, from the network device, a joint indication of the backhaul and access beams, the joint indication of the backhaul and access beams used to indicate both the backhaul and access beams.

In some embodiments, the joint indication of the backhaul and access beams comprises a second beam index associated with at least one of: a first beam width of the access beam and a second beam width of the backhaul beam, the number of access beams with the first beam width and the number of backhaul beams with the second beam width, or a channel associated with the backhaul and access beams.

In some embodiments, the second beam index comprises a first set of bits for the backhaul beam and a second set of bits for the access beam, the second set of bits following the first set of bits.

In some embodiments, the method further comprises determining a valid pair of a backhaul beam of the repeating device and a beam of the network device, wherein the joint indication of the backhaul and access beams is determined based on the valid pair.

In some embodiments, the method further comprises transmitting, to the network device, information about a pair of the backhaul beam of the repeating device and the beam of the network device, the information being associated with at least one of: strength of received signals on a plurality of pairs of backhaul beams of the repeating device and beams of the network device, or a plurality of beams of the network device associated with a backhaul beam of the repeating device, and strength of received signals on the plurality of beams of the network device.

In some embodiments, the method further comprises transmitting, to the network device, an indication of time associated with at least one of: decoding of at least one indication of the at least one of the backhaul or access beam, information transmission from a control module to a forwarding module of the repeating device, or switching of the backhaul and access beams.

In one solution, a method of communication comprises: at a repeating device, determining that at least one condition is met, the at least one condition comprising at least one of: a condition that a second channel measurement of the repeater device is completed in a link between the repeater device and a network device, or a condition that an indication of enabling a forwarding module of the repeating device is received from the network device; and in accordance with a determination that the at least one condition is met, enabling the forwarding module of the repeating device for forwarding to a terminal device.

In some embodiments, the method further comprises receiving, from the network device, an indication of a reference signal resource for the second channel measurement of the repeater device, the reference signal resource having an offset below a threshold offset.

In some embodiments, the method further comprises receiving, from the network device, an indication of periodicity for reporting strength of received signals on a reference signal resource for the second channel measurement, the periodicity being above threshold periodicity.

In some embodiments, the method further comprises transmitting, to the network device, a report for the second channel measurement, wherein the indication of enabling the forwarding module is received from the network device in response to transmitting the report.

In one solution, a method of communication comprises: at a terminal device, receiving, from a network device, a deactivation indication of a channel state information report during a first channel measurement of a terminal device via beam sweeping; and ceasing the channel state information report.

In some embodiments, the method further comprises receiving, from the network device, an indication of a time offset for reactivating the channel state information report.

In some embodiments, the indication of the time offset comprises an offset of an index of a reference signal resource for the first channel measurement.

In another solution, a device of communication comprises: a processor configured to cause the device to perform any of the methods above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 14. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-20. (canceled)

21. A method performed by a repeater, comprising:
receiving, from a network device, a radio resource control (RRC) message comprising a configuration indicating a bitwidth of a beam index field in downlink control information (DCI); and
receiving, from the network device, the DCI comprising at least one beam index based on the bitwidth indicated by the configuration, wherein the at least one beam index is used for an access link between the repeater and a terminal device.

22. The method of claim 21, further comprising:
transmitting, to the network device, capability information of the repeater, wherein the capability information is used to determine an application time for the at least one beam index.

23. The method of claim 21, wherein a transmission configuration indication (TCI) state for a backhaul link between the repeater and the network device is same as a TCI state for a control link between the repeater and the network device.

24. The method of claim 23, wherein the TCI state for the backhaul link is semi-statically transmitted.

25. The method of claim 21, wherein the at least one beam index is associated with an on-off state of the access link.

26. The method of claim 21, wherein the repeater does not transmit or receive before a measurement of a control link between the repeater and the network device is completed.

27. A method performed by a network device, comprising:
transmitting, to a repeater, a radio resource control (RRC) message comprising a configuration indicating a bitwidth of a beam index field in downlink control information (DCI); and
transmitting, to the repeater, the DCI comprising at least one beam index based on the bitwidth indicated by the configuration, wherein the at least one beam index is used for an access link between the repeater and a terminal device.

28. The method of claim 27, further comprising:
receiving, from the repeater, capability information of the repeater, wherein the capability information is used to determine an application time for the at least one beam index.

29. The method of claim 27, wherein a transmission configuration indication (TCI) state for a backhaul link between the repeater and the network device is same as a TCI state for a control link between the repeater and the network device.

30. The method of claim 29, wherein the TCI state for the backhaul link is semi-statically transmitted.

31. The method of claim 27, wherein the at least one beam index is associated with an on-off state of the access link.

32. The method of claim 27, wherein the repeater does not transmit or receive before a measurement of a control link between the repeater and the network device is completed.

33. A repeater, comprising:
a processor configured to cause the repeater to:
receive, from a network device, a radio resource control (RRC) message comprising a configuration indicating a bitwidth of a beam index field in downlink control information (DCI); and
receive, from the network device, the DCI comprising at least one beam index based on the bitwidth indicated by the configuration, wherein the at least one beam index is used for an access link between the repeater and a terminal device.

34. The repeater of claim 33, wherein the repeater is further caused to:
transmit, to the network device, capability information of the repeater, wherein the capability information is used to determine an application time for the at least one beam index.

35. The repeater of claim 33, wherein a transmission configuration indication (TCI) state for a backhaul link between the repeater and the network device is same as a TCI state for a control link between the repeater and the network device.

36. The repeater of claim 35, wherein the TCI state for the backhaul link is semi-statically transmitted.

37. The repeater of claim 33, wherein the at least one beam index is associated with an on-off state of the access link.

38. The repeater of claim 33, wherein the repeater does not transmit or receive before a measurement of a control link between the repeater and the network device is completed.

39. A network device, comprising:
a processor configured to cause the network device to:
transmit, to a repeater, a radio resource control (RRC) message comprising a configuration indicating a bitwidth of a beam index field in downlink control information (DCI); and
transmit, to the repeater, the DCI comprising at least one beam index based on the bitwidth indicated by the configuration, wherein the at least one beam index is used for an access link between the repeater and a terminal device.

40. The network device of claim 39, wherein the network device is further caused to:
receive, from the repeater, capability information of the repeater, wherein the capability information is used to determine an application time for the at least one beam index.

41. The network device of claim 39, wherein a transmission configuration indication (TCI) state for a backhaul link between the repeater and the network device is same as a TCI state for a control link between the repeater and the network device.

42. The network device of claim 41, wherein the TCI state for the backhaul link is semi-statically transmitted.

43. The network device of claim 39, wherein the at least one beam index is associated with an on-off state of the access link.

44. The network device of claim 39, wherein the repeater does not transmit or receive before a measurement of a control link between the repeater and the network device is completed.
